(19) United States
(12) Patent Application Publication
(10) Pub. No.: US 2016/0328396 A1
(43) Pub. Date: Nov. 10, 2016

(54) COLLABORATIVE INTELLIGENT MEDIA PLAYLISTS

(71) Applicant: Blackfire Research Corporation, San Francisco, CA (US)

(72) Inventor: Ravi U. Rajapakse, San Francisco, CA (US)

(21) Appl. No.: 15/147,584

(22) Filed: May 5, 2016

Related U.S. Application Data
(60) Provisional application No. 62/157,473, filed on May 6, 2015.

(51) Int. Cl. G06F 17/30; H04L 29/06

(52) U.S. Cl. CPC G06F 17/3002; H04L 65/4069; H04L 65/80; G06F 17/30053

(57) ABSTRACT

A system for providing collaborative intelligent media playlists, comprising a playlist server that stores and operates an ordered list of media identifiers, a media indexing server that stores media identifiers and media resource locators, and an integration server that operates software-based interfaces for communication with electronic devices via a network, and a method for providing collaborative intelligent media playlists.

### CROSS-REFERENCE TO RELATED APPLICATIONS

The present claims the benefit of and priority to U.S. provisional application Ser. No. 62/157,473 titled “COLLABORATIVE SMART MEDIA PLAYLISTS” filed on May 6, 2015, the entire specification of which is incorporated herein by reference in its entirety.

### BACKGROUND OF THE INVENTION

1. Field of the Invention

The disclosure relates to the field of multimedia consumption, and more particularly to the field of creating and using media playlists with multiple users.

2. Discussion of the State of the Art

In the field of multimedia consumption, it is common to utilize a “playlist” comprising an ordered list of media for playback. Playlists may be carefully arranged or “shuffled”, or arranged in a random or semi-random order, and users generally provide manual input to select media for inclusion in a playlist. In the art there is a growing trend to use playlists in a decentralized manner, with playlists being hosted on network-accessible servers for use on multiple devices, rather than using a local playlist specific to a particular device (for example, YOUTUBE™ playlists or media streaming services that provide playlist functionality such as ITUNES MATCH™, PANDORA™ or SPOTIFY™). However, such decentralized playlists are still linked to a specific user and generally restricted to a particular media service or library for selection of files for consumption-PANDORA™ playlists are stored on a per-account basis for users, and only comprise media hosted and provided by the PANDORA™ service, for example.

What is needed, is a means to provide collaborative intelligent playlists, that may be managed and configured by multiple users with equal privileges for use in group consumption settings, and that are broad in their media selection through the use of indexing, matching, or manual configuration across a plurality of media sources such as streaming services or file storage libraries.

### SUMMARY OF THE INVENTION

Accordingly, the inventor has conceived and reduced to practice, in a preferred embodiment of the invention, a system and method for operating collaborative intelligent media playlists.

To address the problem of providing a means to create collaborative media playlists, the inventors conceived and reduced to practice a device that allows one or more users to assemble playlists of media content, possibly from multiple sources, into a single playlist employing an easy-to-use interface that can be configured to allow each user significant control over content version selection or to allow the device to perform many of the needed steps automatically. Using network connected media playback devices such as mp3 players, smart phones, tablets, laptop computers, and desktop computers one or more users can collaboratively create a playlist of media content with the ability to draw that content from multiple sources such as cloud based music lockers including ITUNES MATCH™, AMAZON CLOUD MUSIC™, and GOOGLE PLAY MUSIC™, internet subscription music services including SPOTIFY™, APPLE MUSIC™ and RDIO™ or locally stored media content files, possibly through ITUNES™ or AMAZON MUSIC™ for which one or more of the device users have the rights. The device acts to intelligently combine content from all of these sources seamlessly, and, when multiple versions of differing sample rates are known to the system, the version of greatest quality is intelligently chosen. Under certain conditions, network connection speed may prevent reliable streaming of media content above a certain sampling rate, under such circumstances, the system will automatically stream a content file of lesser complexity. In the event of video content playlists, the device is programmed to individually stream versions of resolutions that match the rendering capabilities of each of the displays involved in playback, if the files are available. For these reasons, the device surpasses all currently available alternatives.

According to a preferred embodiment of the invention, system for providing collaborative intelligent media playlists, comprising a playlist server computer comprising at least a plurality of programming instructions stored in a memory operating on a network-connected computing device and adapted to store at least an ordered list of a plurality of media identifiers; a media indexing server computer comprising at least a plurality of programming instructions stored in a memory operating on a network-connected computing device and adapted to store at least a plurality of media identifiers and a plurality of media resource locators; and an integration server computer comprising at least a plurality of programming instructions stored in a memory operating on a network-connected computing device and adapted to operate at least a plurality of software-based interfaces for communication with a plurality of electronic devices via a data communication network, wherein the integration server computer operates a software interface adapted to receive user interaction and provide the results of the user interaction to other components of the system; wherein the playlist server computer generates and stores at least a plurality of media identifiers based at least in part on a received user interaction result, and provides at least a media identifier to the media indexing server computer; wherein the media indexing server generates and stores at least a plurality of media information based on a received user interaction result; and wherein the media indexing server generates and stores at least a plurality of media information associations, the media information associations based at least in part on a received media identifier and at least a portion of the stored media information, is disclosed.

According to another embodiment of the invention, system where an integration server computer receives at least a plurality of media file data from a connected electronic device and sends a media resource locator to the media indexing server, the media resource locator being based at least in part on the received media file data; and the media indexing server generates and stores a media resource association based at least in part on the received media resource locator and at least in part on a stored media information association. Media indexing server computer analyzes at least a plurality of media file data and generates at least a media resource association based at least in part on the analysis results. Playlist server sends at least a media identifier to the media indexing server, the media identifier based at least in part on a stored ordered list of media identifiers; and the media indexing server sends a media resource locator to the integration server, the media resource locator being based at least in part on the received media identifier and at least in part on a stored media resource association; and the integration server retrieves at least a plurality of media file data from a connected electronic device, the media file data being based at least in part on the received media resource locator. Integration server provides the retrieved media file data to at least a plurality of connected electronic devices. A plurality of connected electronic devices comprises at least a media player device. Media files are provided by the integration server in a streaming fashion. Connected electronic device comprises at least a server computer operating at least a streaming media software application. Integration server may stream differing versions of a specific media selection based on playlist author preference, the capabilities of the media player device or environmental factors which may impact delivery of the streamed data.

According to another preferred embodiment, method for providing collaborative intelligent media playlists, comprising the steps of: receiving, at an integration server computer, a user interaction; providing the results of a user interaction to other components of a collaborative intelligent media playlist system; generating, at a playlist server computer, at least a media identifier based on at least a received user interaction result; sending at least a media identifier to a media indexing server computer; generating, at a media indexing server computer, a plurality of media information based at least in part on a received user interaction result; storing at least a portion of the plurality of generated media information for future reference; and generating at least a media information association based at least in part on a received media identifier and at least a portion of a plurality of stored media information, is disclosed.

### BRIEF DESCRIPTION OF THE DRAWING FIGURES

The accompanying drawings illustrate several embodiments of the invention and, together with the description, serve to explain the principles of the invention according to the embodiments. It will be appreciated by one skilled in the art that the particular embodiments illustrated in the drawings are merely exemplary, and are not to be considered as limiting of the scope of the invention or the claims herein in any way.

FIG. 1 is a block diagram of an exemplary system architecture for providing collaborative intelligent media playlists, according to a preferred embodiment of the invention

FIG. 2 is a method flow diagram for an exemplary method for providing collaborative intelligent media playlists, according to a preferred embodiment of the invention.

FIG. 3 is a method flow diagram for an exemplary method for providing collaborative intelligent media playlists where multiple, differing, versions of an audio performance are available, according to a preferred embodiment of the invention.

FIG. 4 is a method flow diagram for an exemplary method for providing collaborative intelligent media playlists where, multiple, differing versions of a video performance are available, according to a preferred embodiment of the invention.

FIG. 5 is a block diagram illustrating an exemplary hardware architecture of a computing device used in various embodiments of the invention.

FIG. 6 is a block diagram illustrating an exemplary logical architecture for a client device, according to various embodiments of the invention.

FIG. 7 is a block diagram illustrating an exemplary architectural arrangement of clients, servers, and external services, according to various embodiments of the invention.

FIG. 8 is another block diagram illustrating an exemplary hardware architecture of a computing device used in various embodiments of the invention

### DETAILED DESCRIPTION

The inventor has conceived, and reduced to practice, in a preferred embodiment of the invention, a system and method for operating collaborative intelligent media playlists.

One or more different inventions may be described in the present application. Further, for one or more of the inventions described herein, numerous alternative embodiments may be described; it should be appreciated that these are presented for illustrative purposes only and are not limiting of the inventions contained herein or the claims presented herein in any way. One or more of the inventions may be widely applicable to numerous embodiments, as may be readily apparent from the disclosure. In general, embodiments are described in sufficient detail to enable those skilled in the art to practice one or more of the inventions, and it should be appreciated that other embodiments may be utilized and that structural, logical, software, electrical and other changes may be made without departing from the scope of the particular inventions. Accordingly, one skilled in the art will recognize that one or more of the inventions may be practiced with various modifications and alterations. Particular features of one or more of the inventions described herein may be described with reference to one or more particular embodiments or figures that form a part of the present disclosure, and in which are shown, by way of illustration, specific embodiments of one or more of the inventions. It should be appreciated, however, that such features are not limited to usage in the one or more particular embodiments or figures with reference to which they are described. The present disclosure is neither a literal description of all embodiments of one or more of the inventions nor a listing of features of one or more of the inventions that must be present in all embodiments.

Headings of sections provided in this patent application and the title of this patent application are for convenience only, and are not to be taken as limiting the disclosure in any way.

Devices that are in communication with each other need not be in continuous communication with each other, unless expressly specified otherwise. In addition, devices that are in communication with each other may communicate directly or indirectly through one or more communication means or intermediaries, logical or physical.

A description of an embodiment with several components in communication with each other does not imply that all such components are required. To the contrary, a variety of optional components may be described to illustrate a wide variety of possible embodiments of one or more of the inventions and in order to more fully illustrate one or more aspects of the inventions. Similarly, although process steps, method steps, algorithms or the like may be described in a sequential order, such processes, methods and algorithms may generally be configured to work in alternate orders, unless specifically stated to the contrary. In other words, any sequence or order of steps that may be described in this patent application does not, in and of itself, indicate a requirement that the steps be performed in that order. The steps of described processes may be performed in any order practical. Further, some steps may be performed simultaneously despite being described or implied as occurring non-simultaneously (e.g., because one step is described after the other step). Moreover, the illustration of a process by its depiction in a drawing does not imply that the illustrated process is exclusive of other variations and modifications thereto, does not imply that the illustrated process or any of its steps are necessary to one or more of the invention(s), and does not imply that the illustrated process is preferred. Also, steps are generally described once per embodiment, but this does not mean they must occur once, or that they may only occur once each time a process, method, or algorithm is carried out or executed. Some steps may be omitted in some embodiments or some occurrences, or some steps may be executed more than once in a given embodiment or occurrence.

When a single device or article is described herein, it will be readily apparent that more than one device or article may be used in place of a single device or article. Similarly, where more than one device or article is described herein, it will be readily apparent that a single device or article may be used in place of the more than one device or article.

The functionality or the features of a device may be alternatively embodied by one or more other devices that are not explicitly described as having such functionality or features. Thus, other embodiments of one or more of the inventions need not include the device itself.

Techniques and mechanisms described or referenced herein will sometimes be described in singular form for clarity. However, it should be appreciated that particular embodiments may include multiple iterations of a technique or multiple instantiations of a mechanism unless noted otherwise. Process descriptions or blocks in figures should be understood as representing modules, segments, or portions of code which include one or more executable instructions for implementing specific logical functions or steps in the process. Alternate implementations are included within the scope of embodiments of the present invention in which, for example, functions may be executed out of order from that shown or discussed, including substantially concurrently or in reverse order, depending on the functionality involved, as would be understood by those having ordinary skill in the art.

### Conceptual Architecture

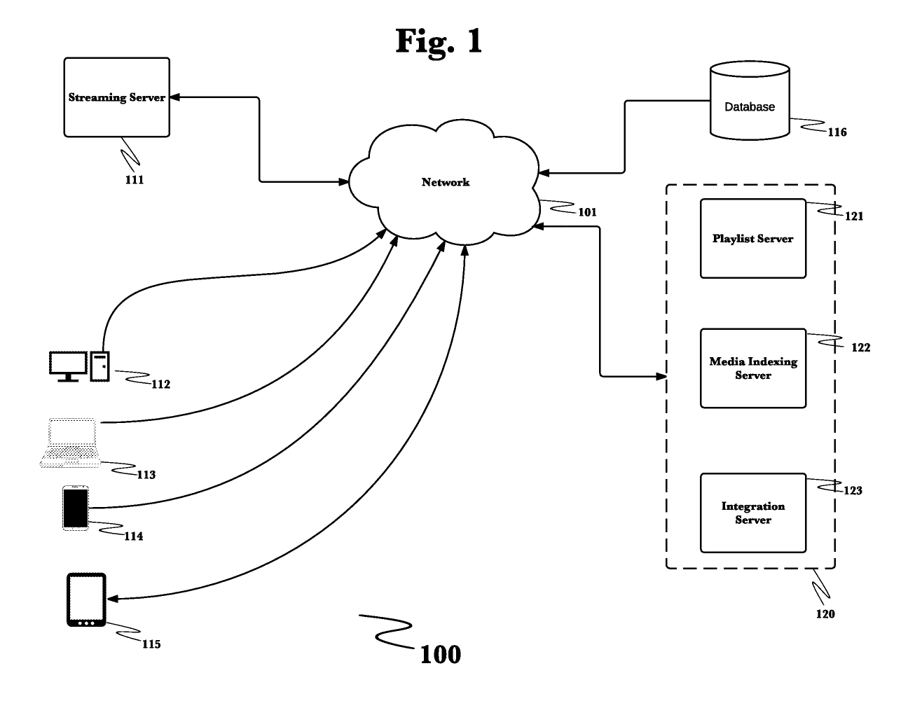

FIG. 1 is a block diagram of an exemplary system architecture 100 for providing collaborative intelligent media playlists, according to a preferred embodiment of the invention. According to the embodiment, a collaborative intelligent media playlist system 120 may be connected to a network 101 such as the Internet or other suitable data communication network, and may receive data over the network 101 for example from any of a variety of network-connected electronic devices. According to the embodiment, electronic devices may include (for example, but not limited to) a media streaming service 111 (such as PANDORA™, SOUNDCLOUD™, YOUTUBE™, or other services that may provide media content in a streaming fashion over a network), a personal computer such as a desktop computer 112 or laptop computer 113, a mobile device such as a smartphone 114 or tablet computing device 115, or a database 116 such as a software or hardware-based data storage medium, for example a SQL™ or similar software-based database schema, optical storage such as DVD or BLU-RAY™, magnetic storage such as hard disk or tape storage drives, or other suitable data storage means.

System 120 may comprise a plurality of elements adapted to operate collaborative intelligent media playlists, such as a playlist server 121 adapted to maintain a playlist comprising a list of media for consumption. A media indexing server 122 may be utilized, and may adapted to receive and process media information such as including, but not limited to, media identifiers including file names, song or film titles, or user-defined identifiers for media, metadata such as ID3 or other tag-based information including but not limited to artist name, year released, media length, media resolution, media sample rate, file size, or other metadata common in the art, or resource locators including but not limited to uniform resource locators (URLs), file paths, or other suitable identifiers that may be used to specify a location where a media file may be stored and from which media may be retrieved for consumption.

An integration server 123 may be utilized according to the embodiment, and may provide a plurality of software or hardware means for integrating with various additional products or services to enhance operation of a system 120. For example, a software application programming interface (API) may enable integration with media playback software such as ITUNES™, for example to make a user's media library available to a media indexing server 122 for indexing. A hardware interface such as a USB or similar electronic communications port, cable, or adapter may be used to integrate physical devices such as storage drives housing media data, media playback devices such as MP3 players or smartphones, or other hardware such as speakers or microphones, may also be utilized to expand the functionality offered by system 120. For example, by integrating a plurality of hardware speakers that may be for example connected wirelessly to system 120, system 120 may provide direct playback of audio without the need for an additional media player device or media software program.

During operation, an integration server 123 may operate an interactive user interface that may enable a user to input media information for inclusion in a playlist, such as a song name or file location, or for a user to input additional information on previously included media. Integration server 123 may provide this information to media indexing server 122 for inclusion in indexing operations (as described below), or to playlist server 121 for inclusion in a playlist. Additional media information may be retrieved from integrated devices, applications, or services, for example file names, locations, or metadata stored on a hard drive or song lyrics retrieved from an online service via an API. In this manner, integration server 123 may be used to make a variety of information available from a plurality of sources, and additional sources may be incorporated as desired in a particular arrangement. Additionally, multiple users may interact with integration server 123, for example via a web-accessible interface or via a mobile app on their personal devices, enabling each user to add their own media information or sources (such as media stored locally on a user's device, or account information to utilize a particular user's subscription to an online media streaming or storage service). In this manner, multiple users with equal, pre-arranged privileges, may interact with playlists facilitating group management and expanding the available media files and information for use in a collaborative arrangement.

Media indexing server 122 may receive a plurality of media information including but not limited to file names or locations, metadata, source information (such as “available on PANDORA™ or “stored on local disk”, or other such information that may be used to identify the source of an available media file), and may perform indexing operations on this data to process it for use in playlist operations. Such operations may comprise maintaining a “media locker”, that may be an electronic catalog of media information such as file names, metadata, and file locations. In this manner a media locker may be referenced to locate specific media files, as well as to retrieve information pertaining to those files. This may be used to combine media from multiple sources into a single unified catalog for easy reference and browsing, enabling a user to select media from a single list while indexing server 122 identifies the media location and requests the media from integration server 123 for retrieval from the associated media source as needed. Additional operations may include media association, that may identify media information input by a user (such as a song title or track number), and associate this information with other previously stored or new information, such as a file location. In this manner, a user may update media information without necessarily adding new media files, file associations may be updated as needed such as when new versions of media are added to a media locker, and duplicate media may be identified and simplified to clean up a locker (for example, by associating the relevant information with the source that provides the highest-quality recording, or fastest network connection).

During media indexing by an indexing server 122, media identifiers and media information (such as file metadata) may be processed and analyzed to determine ideal matches with media files received from media sources added to an integration server 123, for example to identify a specific version of a media file to use with a particular identifier. For example, a song title may have multiple versions from different recordings, covers recorded by different artists, remixes, or alternate lyrics. A single media file may be selected from a multitude of available media files through analysis of associated media information, for example if a user specifies “original version” on a song, it may be assumed they mean the very first studio recording by the original artist. If additional files are available, they may be identified as alternative matches and the resource locators for those files stored for future reference (for example, if a user later requests a specific alternate version, or their preferences change, or another user interacts with a playlist and selects an alternate version). Additionally, users may be given options for configuring operation via an interface operated by an integration server 123, such as for example checkboxes to select genres of music they prefer, text fields to input specific metadata tags to avoid, or configurable notification prompts that may alert that particular user and ask for their input when making an indexing decision. For example, a user may be notified to select from a plurality of possible media file matches, or to allow or deny another user's changes (for example, to prevent conflicts caused by a user with different tastes or that is changing a playlist without permission). For example, several individuals in a workplace setting might be setting up a playlist for media playback while they work. They may have specific preferences regarding media versions such as song covers or videos with commentary tracks, and want to specify what media to use with a fine degree of control as they plan to use this playlist frequently. Another example may be a family setting, where parents may wish to restrict the content selected for playback to prevent their children from viewing media of a certain rating or genre. In another example, home users may wish to configure multiple playlists setup for different occasions, such as separate playlists for holidays, by specifying what versions or types of media to select when multiple choices are found. Another example may be a user that has relaxed tastes, and just wants to setup a quick playlist for commuting to work. They may choose to disable prompts and skip detailed preference configuration, instead choosing to allow indexing server 122 to make choices regarding media files, for the sake of a quick and convenient playlist setup experience. It should be appreciated that these and a variety of other such use cases may be possible according to the embodiment, by providing users with the option for a variety of configuration options and granularity levels, but without requiring any specific configuration so that users have the choice to configure as much or as little of an indexing operation as they desire.

Indexing operations may be configurable by a user (or by multiple users, each setting preferences for a single collaborative playlist, such as individual music tastes for example so that a single playlist may be operated that comprises media agreeable to everyone), for example to optimize a media locker for a particular use such as a “mobile locker” that places preference on lower media sample rates or local availability when network connections may be slowed or intermittent. Additionally, in a collaborative arrangement as described previously, multiple users may add information for similar media, such as when two individuals each have a copy of a particular song or video. During indexing operations, this similarity may be identified and multiple copies of a media file may be processed to determine which copy to use, for example by comparing the available media files and information against configured preferences for a particular media locker (such as “prefer high quality”). The media information may then be associated with the preferred copy of the media, and duplicates may be stored as “backup” copies (such as if a user's personal media source on which the “highest quality” version is unavailable), or discarded. In this manner “smart” playlists may be provided, where media content is intelligently optimized during operation.

For example, if two friends “Jack” and “Jill” are operating a collaborative smart playlist for a party, Jack might add “Song 1” to the playlist, and a media indexing server 122 may then recognize that Jill has a copy of “Song 1” that was recorded at a higher bit rate (thus having greater audio quality). Media indexing server 122 may then use Jill's copy of the song when it is selected for playback, such as when the playlist reaches that song's position in the queue. Neither user need manually configure this operation or even be aware that it is taking place, as implied permission is drawn from their participation in and operation of the collaborative playlist. If a particular user wishes to keep some or all of their media private, they may simply choose not to add that media for use by an integration server 123 (such as via selection in an interface when they begin a playlist or sign up to use a service the employs a collaborative intelligent media playlist system 100).

Another example of collaborative intelligent media playlist functionality may be a family watching a series of television episodes, from a playlist with a preference for “with director's commentary”. For each episode (that is, each media identifier in the playlist), the “best” version may be automatically selected. If one family member adds a media library that contains an episode with the director's commentary included, that version may be selected rather than a “non-commentary” version that was available when the playlist was first created or the media identifier was added to it. In this manner, media may be intelligently enhanced at the time of requesting a particular media file for playback, enabling live updates to playlist simply by making more media available to choose from, without the need for a user to manually reconfigure a playlist to use new or alternate files.

Another added functionality that may be provided by an integration server 123, is that of multi-stream media playback. In such an arrangement, when multiple media sources are configured, media may be requested from more than one source for simultaneous consumption. For example, different audio files may be played to separate speakers, or video files to different television displays (for example standard definition media to standard def. displays, the appropriate high definition standard 720p, 1080i, and 4k encoded media to ultra-high definition displays). A further use according to such an arrangement, may be that of uninterrupted playback for ad-supported sources such as media streaming services like YOUTUBE™, PANDORA™, or SPOTIFY™. For example, such services commonly play advertisements between media files to increase revenue from users (generally users with free subscription accounts). According to a multi-stream arrangement, when an ad is played from a particular source, the playback stream may be quieted or muted while being allowed to continue playing. At the same time, another source may be used for the next media file request, such that a user experiences no interruption of media playback—advertisements play silently in the background while they continue listening to their playlist. In this manner, users may be encouraged to expand their media libraries through the use of ad-supported services, and service providers may be encouraged to support such use as they may increase their user base without losing ad revenue (as the advertisements continue playing and generating revenue for the provider regardless of whether a person actually hears them at the point of consumption). It can be appreciated that such an arrangement further benefits as more users add their own media sources, again encouraging users to interact and use collaborative playlists.

### Detailed Description of Exemplary Embodiments

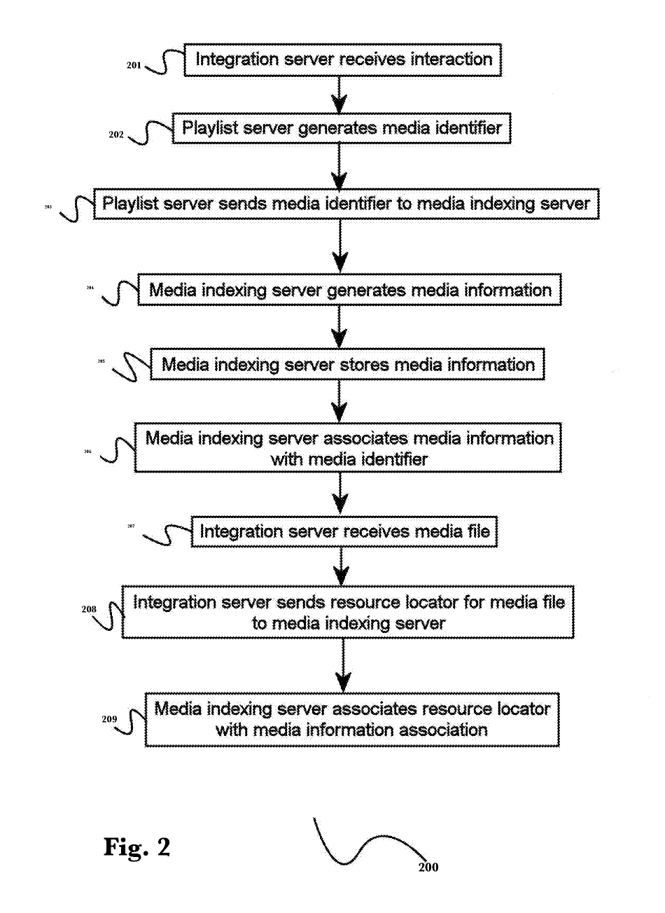

FIG. 2 is a method flow diagram for an exemplary method 200 for providing collaborative intelligent media playlists, according to a preferred embodiment of the invention. In an initial step 201, an integration server may receive user interaction, for example via a web interface or mobile software application. In a next step 202, this interaction may be provided to a playlist server which may then produce a media identifier, such as a song name, movie title, or other identifier that may be used to identify specific media content (for example, if a user types a specific song name into the interface or application, that name may be used as a media identifier). In a next step 203, the playlist server may provide a media identifier to a media indexing server, that may then generate media information in a next step 204. For example, a media indexing server may receive additional input from a user (such as via an interface operated by an integration server, as described previously), and use this input in the generation of media information. In a next step 205, the media indexing server may store the media information for future reference, and in a next step 206 it may associate media information with a media identifier. For example, when a media indexing server receives a media identifier from a playlist server, it may select previously-stored or new media information for association and store this association. In a next step 207, an integration server may receive a media file such as when a user provides a specific media file (such as a particular song or video), or by requesting a media file from storage or a streaming service. In a next step 208, the integration server may provide a resource locator to a media indexing server, such as a URL or a file path corresponding to the received media file. In a final step 209, the media indexing server may associate a received resource locator with a new or previously-stored media association comprising a media identifier and a plurality of media information. In this manner, a media file may now be associated with an identifier for ease of reference and presentation to a user, a plurality of media information such as metadata commonly associated with media files, and a resource locator for locating, requesting, or retrieving the media file for use.

According to the embodiment, users may provide a variety of media information comprising file names, song or video titles, names of actors, artists, directors, or other associated persons, ratings, or arbitrary tags such as categories or keywords for ease of search or identification. This information may then be used in the selection or retrieval of media, for example by providing a search functionality that may accept queries from a user comprising any associated media information to locate specific media files.

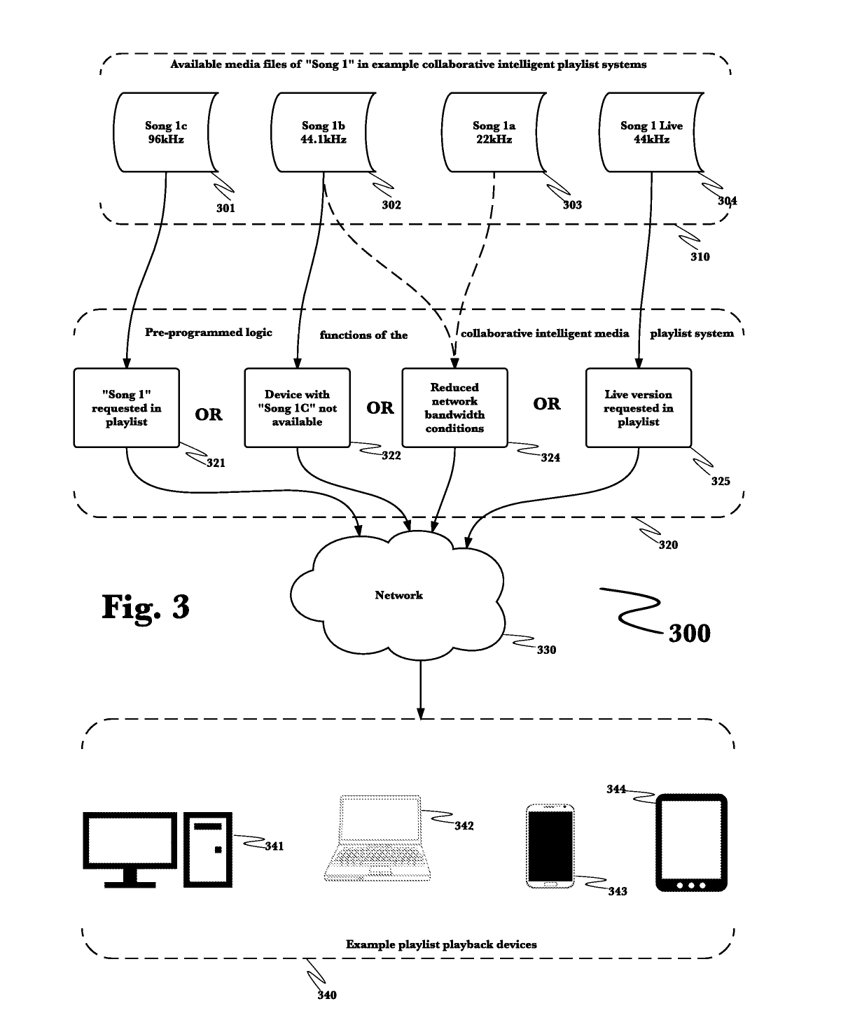

FIG. 3 is a method flow diagram for an exemplary method for providing collaborative intelligent media playlists where multiple, differing, versions of an audio performance are available 300, according to a preferred embodiment of the invention. As described in FIG. 1 it is often the case that more than one copy or version of a particular audio performance 310, such as, but not limited to a song, a speech, a lecture or a comedy routine will become present within the media index of the collaborative intelligent playlist system and available to the users of that system 301, 302, 303, 304. These “versions” may differ, for example, in sample rate in which the content is stored, or conditions under which the version was recorded, for a song, this may be a studio vs. live recording or the artist performing the song may be different, just to name a very few possible factors known to those skilled in the art. Under the embodiment, if the user or users of a playlist only specify the song, to use the type of recording chosen as the example in the FIG. 300, the preprogrammed logic of the invention 320 with stream the file of the song with the highest sample rate 321, or quality to the playback devices 340 (341, 342, 343, 344). There will be circumstances that make streaming the file with the highest sample rate impossible 322, or a less desirable choice than another option 323. For example, if the file with the highest sample rate is not available at the time playback of the target song is to begin 322, the pre-programmed logic of the system 320 will select and stream the available file with the highest sample rate 302. Alternatively, network congestion or environmental conditions may create a situation where the bandwidth available on the network cannot support smooth continuous playback of the target song 324 at the highest available sample rate. Under this condition, the system logic 320 will stream a file of the highest band width calculated by it to play without significant disruption 302, 303. Last, the author or authors of the playlist may have specifically selected a version of the song that does not have the highest sampling rate, but possesses attributes of greater value to them, for example a “live” performance version 304. Under this condition, the author selected version is streamed, if available. If not available, the version highest sample rate 301 may be played, the song skipped entirely or an error message sent to the playback devices as previously decided by the authors. Though not depicted, versions of audio files may exist that are encoded for differing speaker systems, for example, a set of audio files may accompany a multimedia package that also includes video and in that case, one version of the audio file may be encoded for a stereo audio playback system while other version of the audio file may be encoded for playback on one or more types of 5.1 ‘surround sound” speaker systems. Insuring the correct speaker version is streamed to the correct playback devices would also be carried out by the logic programming.

It should be realized that the examples of the possible preprogrammed logic functions of the invention were chosen more to illustrate the possible working of the system using a very small number of choices and circumstances and should not be understood to limit the logic choices available to the invention or the situations that the invention may be programmed to logically act upon.

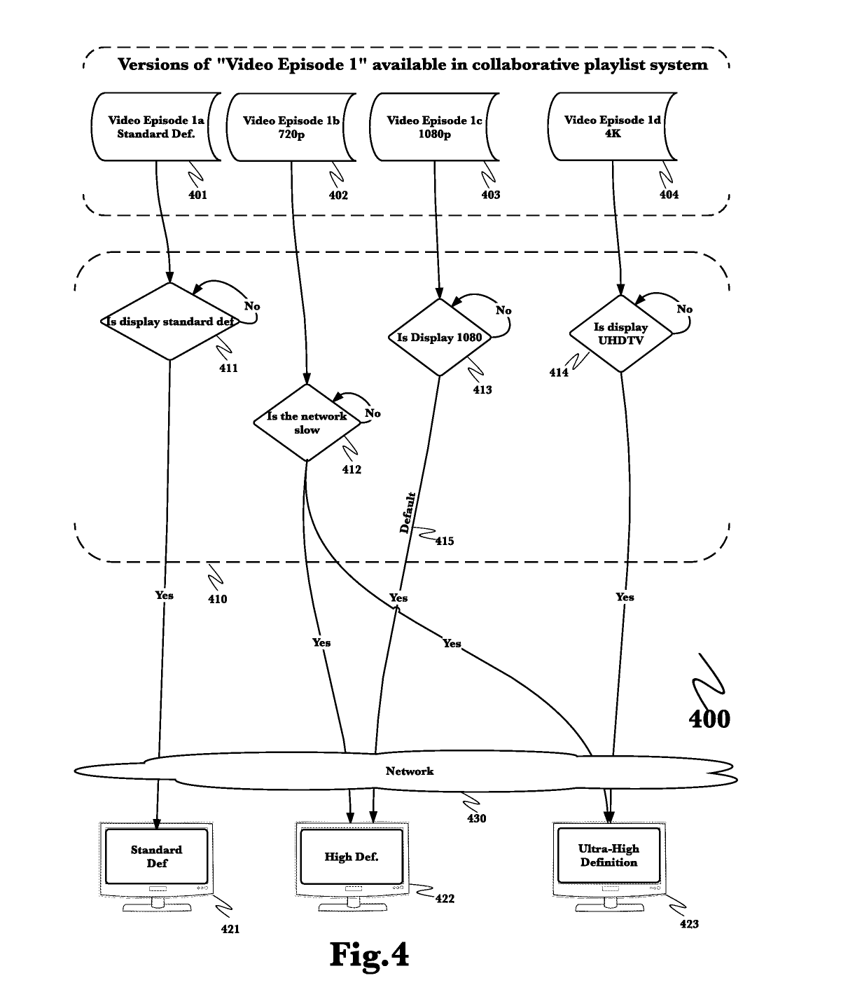

FIG. 4 is a method flow diagram for an exemplary method for providing collaborative intelligent media playlists where, multiple, differing versions of a video performance are available 400, according to a preferred embodiment of the invention. Video standards have advanced rapidly over the past decade with video resolution increasing significantly. Files for video playback are created for these different resolutions and some video content have 4 or more different “versions” to account for this 401, 402, 403, 404. Integration server of intelligent collaborative playlist system 410 is programmed to administer the proper selection of video file versions for streaming based on playback device present and environmental factors. For example, the displays on which the video file is played back may be standard-definition 421, high-definition 422, or ultra-high-definition 423. Standard definition displays 421 can only render standard definition media files 401 and therefore the integration server will only send standard definition encoded files 411 to those displays 421. Absence of a standard definition encoded file may result in an error message being sent from the integration server 410 to standard displays 421. Most high definition displays 422 can render both 720p 402 and 1080i 403 encoded files, but the system will stream the higher resolution 1080i file when available 413, 415. Recently, ultra-high-definition or 4k displays 423 have entered the consumer market in large numbers. These displays can display 4k encoded video files and the integration server 410 will stream that file 414 to 4k displays 423 when the file version is available. Thus, the same video content can often be concurrently displayed on the displays of intelligent collaborative playlist users at the highest possible resolution possible regardless of the resolution capabilities of the display they are using. Sometimes, environmental factors, such as a slow network 430 may make streaming the higher resolution video file versions 403, 404 impractical 412 as such streaming would result in frequent frozen frames and drop outs. Under conditions known to negatively impact playback, the integration server may choose a different, in our network example, lower resolution, file version 402.

It should be realized that the examples of the possible preprogrammed logic functions of the invention were chosen more to illustrate the possible working of the system using a very small number of choices and circumstances and should not be understood to limit the logic choices available to the invention or the situations that the invention may be programmed to logically act upon.

### Hardware Architecture

Generally, the techniques disclosed herein may be implemented on hardware or a combination of software and hardware. For example, they may be implemented in an operating system kernel, in a separate user process, in a library package bound into network applications, on a specially constructed machine, on an application-specific integrated circuit (ASIC), or on a network interface card.

Software/hardware hybrid implementations of at least some of the embodiments disclosed herein may be implemented on a programmable network-resident machine (which should be understood to include intermittently connected network-aware machines) selectively activated or reconfigured by a computer program stored in memory. Such network devices may have multiple network interfaces that may be configured or designed to utilize different types of network communication protocols. A general architecture for some of these machines may be described herein in order to illustrate one or more exemplary means by which a given unit of functionality may be implemented. According to specific embodiments, at least some of the features or functionalities of the various embodiments disclosed herein may be implemented on one or more general-purpose computers associated with one or more networks, such as for example an end-user computer system, a client computer, a network server or other server system, a mobile computing device (e.g., tablet computing device, mobile phone, smartphone, laptop, or other appropriate computing device), a consumer electronic device, a music player, or any other suitable electronic device, router, switch, or other suitable device, or any combination thereof. In at least some embodiments, at least some of the features or functionalities of the various embodiments disclosed herein may be implemented in one or more virtualized computing environments (e.g., network computing clouds, virtual machines hosted on one or more physical computing machines, or other appropriate virtual environments).

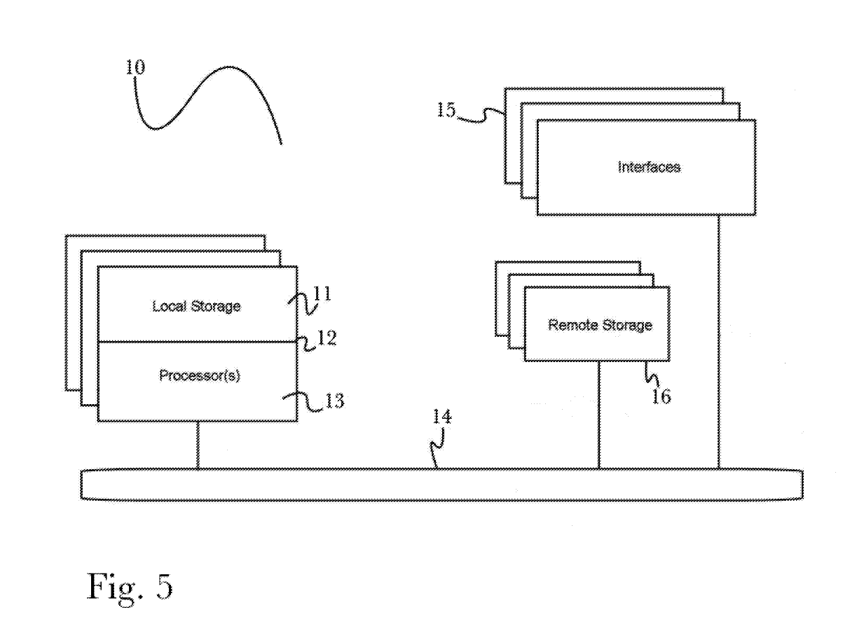

Referring now to FIG. 5, there is shown a block diagram depicting an exemplary computing device 10 suitable for implementing at least a portion of the features or functionalities disclosed herein. Computing device 10 may be, for example, any one of the computing machines listed in the previous paragraph, or indeed any other electronic device capable of executing software- or hardware-based instructions according to one or more programs stored in memory. Computing device 10 may be configured to communicate with a plurality of other computing devices, such as clients or servers, over communications networks such as a wide area network a metropolitan area network, a local area network, a wireless network, the Internet, or any other network, using known protocols for such communication, whether wireless or wired.

In one embodiment, computing device 10 includes one or more central processing units (CPU) 12, one or more interfaces 15, and one or more busses 14 (such as a peripheral component interconnect (PCI) bus). When acting under the control of appropriate software or firmware, CPU 12 may be responsible for implementing specific functions associated with the functions of a specifically configured computing device or machine. For example, in at least one embodiment, a computing device 10 may be configured or designed to function as a server system utilizing CPU 12, local memory 11 and/or remote memory 16, and interface(s) 15. In at least one embodiment, CPU 12 may be caused to perform one or more of the different types of functions and/or operations under the control of software modules or components, which for example, may include an operating system and any appropriate applications software, drivers, and the like.

CPU 12 may include one or more processors 13 such as, for example, a processor from one of the Intel, ARM, Qualcomm, and AMD families of microprocessors. In some embodiments, processors 13 may include specially designed hardware such as application-specific integrated circuits (ASICs), electrically erasable programmable read-only memories (EEPROMs), field-programmable gate arrays (FPGAs), and so forth, for controlling operations of computing device 10. In a specific embodiment, a local memory 11 (such as non-volatile random access memory (RAM) and/or read-only memory (ROM), including for example one or more levels of cached memory) may also form part of CPU 12. However, there are many different ways in which memory may be coupled to system 10. Memory 11 may be used for a variety of purposes such as, for example, caching and/or storing data, programming instructions, and the like. It should be further appreciated that CPU 12 may be one of a variety of system-on-a-chip (SOC) type hardware that may include additional hardware such as memory or graphics processing chips, such as a Qualcomm SNAPDRAGON™ or Samsung EXYNOS™ CPU as are becoming increasingly common in the art, such as for use in mobile devices or integrated devices.

As used herein, the term “processor” is not limited merely to those integrated circuits referred to in the art as a processor, a mobile processor, or a microprocessor, but broadly refers to a microcontroller, a microcomputer, a programmable logic controller, an application-specific integrated circuit, and any other programmable circuit.

In one embodiment, interfaces 15 are provided as network interface cards (NICs). Generally, NICs control the sending and receiving of data packets over a computer network; other types of interfaces 15 may for example support other peripherals used with computing device 10. Among the interfaces that may be provided are Ethernet interfaces, frame relay interfaces, cable interfaces, DSL interfaces, token ring interfaces, graphics interfaces, and the like. In addition, various types of interfaces may be provided such as, for example, universal serial bus (USB), Serial, Ethernet, FIREWIRE™, THUNDERBOLT™, PCI, parallel, radio frequency (RF), BLUETOOTH™, near-field communications (e.g., using near-field magnetics), 802.11 (WiFi), frame relay, TCP/IP, ISDN, fast Ethernet interfaces, Gigabit Ethernet interfaces, Serial ATA (SATA) or external SATA (ESATA) interfaces, high-definition multimedia interface (HDMI), digital visual interface (DVI), analog or digital audio interfaces, asynchronous transfer mode (ATM) interfaces, high-speed serial interface (HSSI) interfaces, Point of Sale (POS) interfaces, fiber data distributed interfaces (FDDIs), and the like. Generally, such interfaces 15 may include physical ports appropriate for communication with appropriate media. In some cases, they may also include an independent processor (such as a dedicated audio or video processor, as is common in the art for high-fidelity A/V hardware interfaces) and, in some instances, volatile and/or non-volatile memory (e.g., RAM).

Although the system shown and described above illustrates one specific architecture for a computing device 10 for implementing one or more of the inventions described herein, it is by no means the only device architecture on which at least a portion of the features and techniques described herein may be implemented. For example, architectures having one or any number of processors 13 may be used, and such processors 13 may be present in a single device or distributed among any number of devices. In one embodiment, a single processor 13 handles communications as well as routing computations, while in other embodiments a separate dedicated communications processor may be provided. In various embodiments, different types of features or functionalities may be implemented in a system according to the invention that includes a client device (such as a tablet device or smartphone running client software) and server systems (such as a server system described in more detail below).

Regardless of network device configuration, the system of the present invention may employ one or more memories or memory modules (such as, for example, remote memory block 16 and local memory 11) configured to store data, program instructions for the general-purpose network operations, or other information relating to the functionality of the embodiments described herein (or any combinations of the above). Program instructions may control execution of or comprise an operating system and/or one or more applications, for example. Memory 16 or memories 11, 16 may also be configured to store data structures, configuration data, encryption data, historical system operations information, or any other specific or generic non-program information described herein.

Because such information and program instructions may be employed to implement one or more systems or methods described herein, at least some network device embodiments may include nontransitory machine-readable storage media, which, for example, may be configured or designed to store program instructions, state information, and the like for performing various operations described herein. Examples of such nontransitory machine-readable storage media include, but are not limited to, magnetic media such as hard disks, floppy disks, and magnetic tape; optical media such as CD-ROM disks; magneto-optical media such as optical disks, and hardware devices that are specially configured to store and perform program instructions, such as read-only memory devices (ROM), flash memory (as is common in mobile devices and integrated systems), solid state drives (SSD) and “hybrid SSD” storage drives that may combine physical components of solid state and hard disk drives in a single hardware device (as are becoming increasingly common in the art with regard to personal computers), memristor memory, random access memory (RAM), and the like. It should be appreciated that such storage means may be integral and non-removable (such as RAM hardware modules that may be soldered onto a motherboard or otherwise integrated into an electronic device), or they may be removable such as swappable flash memory modules (such as “thumb drives” or other removable media designed for rapidly exchanging physical storage devices), “hot-swappable” hard disk drives or solid state drives, removable optical storage discs, or other such removable media, and that such integral and removable storage media may be utilized interchangeably. Examples of program instructions include both object code, such as may be produced by a compiler, machine code, such as may be produced by an assembler or a linker, byte code, such as may be generated by for example a JAVA™ compiler and may be executed using a Java virtual machine or equivalent, or files containing higher level code that may be executed by the computer using an interpreter (for example, scripts written in Python, Perl, Ruby, Groovy, or any other scripting language).

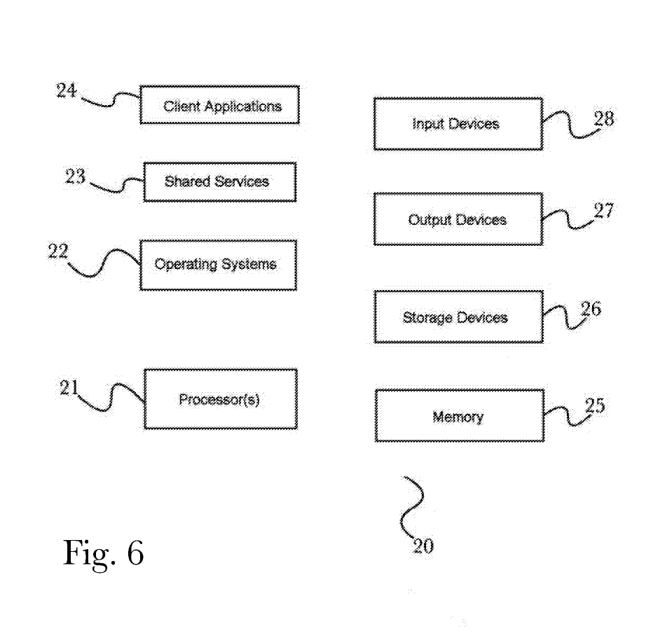

In some embodiments, systems according to the present invention may be implemented on a standalone computing system. Referring now to FIG. 6, there is shown a block diagram depicting a typical exemplary architecture of one or more embodiments or components thereof on a standalone computing system. Computing device 20 includes processors 21 that may run software that carry out one or more functions or applications of embodiments of the invention, such as for example a client application 24. Processors 21 may carry out computing instructions under control of an operating system 22 such as, for example, a version of Microsoft's WINDOWS™ operating system, Apple's Mac OS/X or iOS operating systems, some variety of the Linux operating system, Google's ANDROID™ operating system, or the like. In many cases, one or more shared services 23 may be operable in system 20, and may be useful for providing common services to client applications 24. Services 23 may for example be WINDOWS™ services, user-space common services in a Linux environment, or any other type of common service architecture used with operating system 21. Input devices 28 may be of any type suitable for receiving user input, including for example a keyboard, touchscreen, microphone (for example, for voice input), mouse, touchpad, trackball, or any combination thereof. Output devices 27 may be of any type suitable for providing output to one or more users, whether remote or local to system 20, and may include for example one or more screens for visual output, speakers, printers, or any combination thereof. Memory 25 may be random-access memory having any structure and architecture known in the art, for use by processors 21, for example to run software. Storage devices 26 may be any magnetic, optical, mechanical, memristor, or electrical storage device for storage of data in digital form (such as those described above). Examples of storage devices 26 include flash memory, magnetic hard drive, CD-ROM, and/or the like.

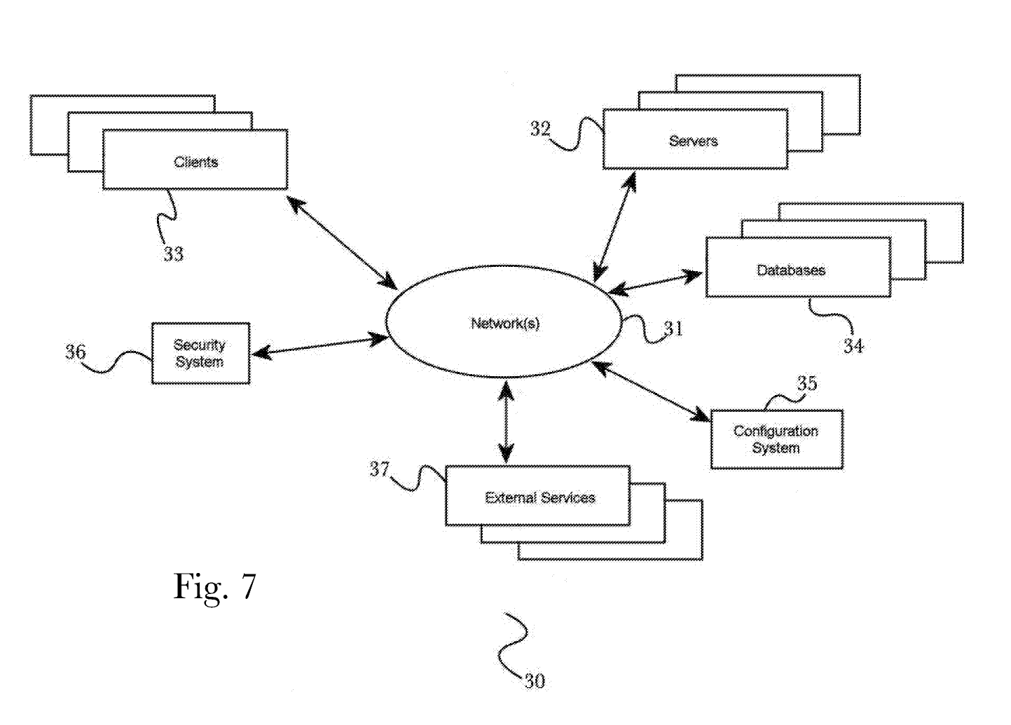

In some embodiments, systems of the present invention may be implemented on a distributed computing network, such as one having any number of clients and/or servers. Referring now to FIG. 7, there is shown a block diagram depicting an exemplary architecture 30 for implementing at least a portion of a system according to an embodiment of the invention on a distributed computing network. According to the embodiment, any number of clients 33 may be provided. Each client 33 may run software for implementing client-side portions of the present invention; clients may comprise a system 20 such as that illustrated above. In addition, any number of servers 32 may be provided for handling requests received from one or more clients 33. Clients 33 and servers 32 may communicate with one another via one or more electronic networks 31, which may be in various embodiments any of the Internet, a wide area network, a mobile telephony network (such as CDMA or GSM cellular networks), a wireless network (such as WiFi, Wimax, LTE, and so forth), or a local area network (or indeed any network topology known in the art; the invention does not prefer any one network topology over any other). Networks 31 may be implemented using any known network protocols, including for example wired and/or wireless protocols.

In addition, in some embodiments, servers 32 may call external services 37 when needed to obtain additional information, or to refer to additional data concerning a particular call. Communications with external services 37 may take place, for example, via one or more networks 31. In various embodiments, external services 37 may comprise web-enabled services or functionality related to or installed on the hardware device itself. For example, in an embodiment where client applications 24 are implemented on a smartphone or other electronic device, client applications 24 may obtain information stored in a server system 32 in the cloud or on an external service 37 deployed on one or more of a particular enterprise's or user's premises.

In some embodiments of the invention, clients 33 or servers 32 (or both) may make use of one or more specialized services or appliances that may be deployed locally or remotely across one or more networks 31. For example, one or more databases 34 may be used or referred to by one or more embodiments of the invention. It should be understood by one having ordinary skill in the art that databases 34 may be arranged in a wide variety of architectures and using a wide variety of data access and manipulation means. For example, in various embodiments one or more databases 34 may comprise a relational database system using a structured query language (SQL), while others may comprise an alternative data storage technology such as those referred to in the art as “NoSQL” (for example, Hadoop Cassandra, Google BigTable, and so forth). In some embodiments, variant database architectures such as column-oriented databases, in-memory databases, clustered databases, distributed databases, or even flat file data repositories may be used according to the invention. It will be appreciated by one having ordinary skill in the art that any combination of known or future database technologies may be used as appropriate, unless a specific database technology or a specific arrangement of components is specified for a particular embodiment herein. Moreover, it should be appreciated that the term “database” as used herein may refer to a physical database machine, a cluster of machines acting as a single database system, or a logical database within an overall database management system. Unless a specific meaning is specified for a given use of the term “database”, it should be construed to mean any of these senses of the word, all of which are understood as a plain meaning of the term “database” by those having ordinary skill in the art.

Similarly, most embodiments of the invention may make use of one or more security systems 36 and configuration systems 35. Security and configuration management are common information technology (IT) and web functions, and some amount of each are generally associated with any IT or web systems. It should be understood by one having ordinary skill in the art that any configuration or security subsystems known in the art now or in the future may be used in conjunction with embodiments of the invention without limitation, unless a specific security 36 or configuration system 35 or approach is specifically required by the description of any specific embodiment.

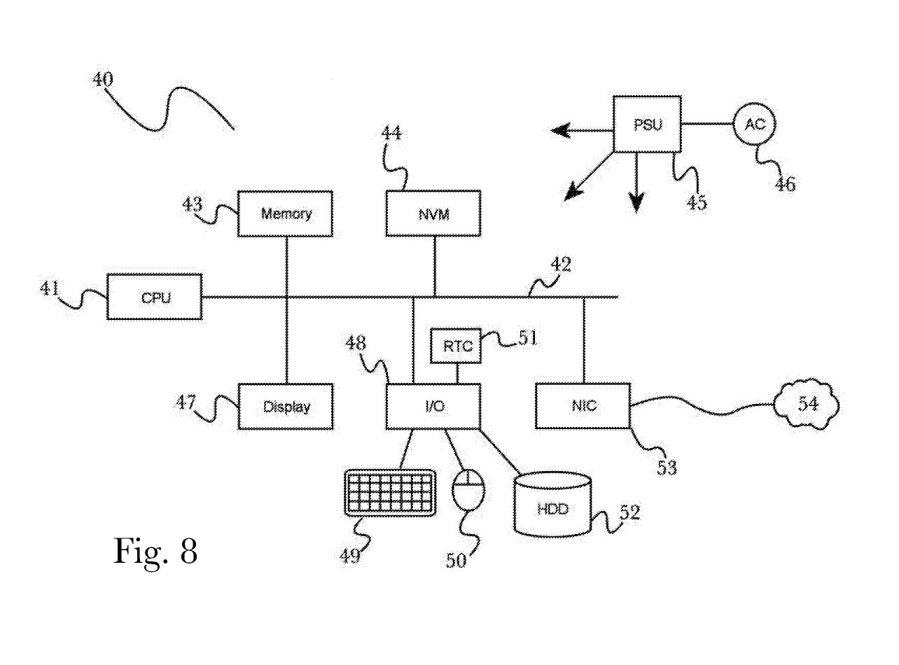

FIG. 8 shows an exemplary overview of a computer system 40 as may be used in any of the various locations throughout the system. It is exemplary of any computer that may execute code to process data. Various modifications and changes may be made to computer system 40 without departing from the broader scope of the system and method disclosed herein. Central processor unit (CPU) 41 is connected to bus 42, to which bus is also connected memory 43, nonvolatile memory 44, display 47, input/output (I/O) unit 48, and network interface card (NIC) 53. I/O unit 48 may, typically, be connected to keyboard 49, pointing device 50, hard disk 52, and real-time clock 51. NIC 53 connects to network 54, which may be the Internet or a local network, which local network may or may not have connections to the Internet. Also shown as part of system 40 is power supply unit 45 connected, in this example, to a main alternating current (AC) supply 46. Not shown are batteries that could be present, and many other devices and modifications that are well known but are not applicable to the specific novel functions of the current system and method disclosed herein. It should be appreciated that some or all components illustrated may be combined, such as in various integrated applications, for example Qualcomm or Samsung system-on-a-chip (SOC) devices, or whenever it may be appropriate to combine multiple capabilities or functions into a single hardware device (for instance, in mobile devices such as smartphones, video game consoles, in-vehicle computer systems such as navigation or multimedia systems in automobiles, or other integrated hardware devices).

In various embodiments, functionality for implementing systems or methods of the present invention may be distributed among any number of client and/or server components. For example, various software modules may be implemented for performing various functions in connection with the present invention, and such modules may be variously implemented to run on server and/or client.

In various embodiments, functionality for implementing systems or methods of the present invention may be distributed among any number of client and/or server components. For example, various software modules may be implemented for performing various functions in connection with the present invention, and such modules may be variously implemented to run on server and/or client components through the use of multiple media sources added via an interface operated by an integration server 121 as described above.

The skilled person will be aware of a range of possible modifications of the various embodiments described above. Accordingly, the present invention is defined by the claims and their equivalents.

What is claimed is:

1. A system for providing collaborative intelligent media playlists, comprising:
a playlist server computer comprising at least a plurality of programming instructions stored in a memory operating on a network-connected computing device and adapted to store at least an ordered list of a plurality of media identifiers;
a media indexing server computer comprising at least a plurality of programming instructions stored in a memory operating on a network-connected computing device and adapted to store at least a plurality of media identifiers and a plurality of media resource locators; and
an integration server computer comprising at least a plurality of programming instructions stored in a memory operating on a network-connected computing device and adapted to operate at least a plurality of software-based interfaces for communication with a plurality of electronic devices via a data communication network;
wherein the integration server computer operates a software interface adapted to receive user interaction and provide the results of the user interaction to other components of the system;
wherein the playlist server computer generates and stores at least a plurality of media identifiers based at least in part on a received user interaction result, and provides at least a media identifier to the media indexing server computer;
wherein the media indexing server generates and stores at least a plurality of media information based on a received user interaction result; and
wherein the media indexing server generates and stores at least a plurality of media information associations, the media information associations based at least in part on a received media identifier and at least a portion of the stored media information.

2. The system of claim 1, further wherein the integration server computer receives at least a plurality of media file data from a connected electronic device and sends a media resource locator to the media indexing server, the media resource locator being based at least in part on the received media file data; and the media indexing server generates and stores a media resource association based at least in part on the received media resource locator and at least in part on a stored media information association.

3. The system of claim 1, wherein the media indexing server computer analyzes at least a plurality of media file data and generates at least a media resource association based at least in part on the analysis results.

4. The system of claim 2, further wherein: the playlist server sends at least a media identifier to the media indexing server, the media identifier based at least in part on a stored ordered list of media identifiers; and the media indexing server sends a media resource locator to the integration server, the media resource locator being based at least in part on the received media identifier and at least in part on a stored media resource association; and the integration server retrieves at least a plurality of media file data from a connected electronic device, the media file data being based at least in part on the received media resource locator.

5. The system of claim 4, wherein the integration server provides the retrieved media file data to at least a plurality of connected electronic devices.

6. The system of claim 5, wherein the plurality of connected electronic devices comprises at least a media player device.

7. The system of claim 5, wherein the media files are provided by the integration server in a streaming fashion.

8. The system of claim 4, wherein the connected electronic device comprises at least a server computer operating at least a streaming media software application.

9. The system of claim 1 wherein the integration server may stream differing versions of a specific media selection based on playlist author preference, the capabilities of the media player device or environmental factors which may impact delivery of the streamed data.

10. A method for providing collaborative intelligent media playlists, comprising the steps of: receiving, at an integration server computer, a user interaction; providing the results of a user interaction to other components of a collaborative intelligent media playlist system; generating, at a playlist server computer, at least a media identifier based on at least a received user interaction result; sending at least a media identifier to a media indexing server computer; generating, at a media indexing server computer, a plurality of media information based at least in part on a received user interaction result; storing at least a portion of the plurality of generated media information for future reference; and generating at least a media information association based at least in part on a received media identifier and at least a portion of a plurality of stored media information.

11. The method of claim 10, further comprising the steps of: receiving, at an integration server computer, a plurality of media file data; sending at least a media resource locator to a media indexing server computer based at least in part on at least a portion of the received media file data; generating, at a media indexing server computer, a media resource association based at least in part on the received media resource locator and at least a portion of a plurality of stored media information associations; and storing the media resource association for future reference.

12. The method of claim 10, further comprising the steps of: analyzing, at a media indexing server computer, a plurality of stored media information associations; analyzing a received media resource locator; and generating a media resource association based at least in part on the analysis results.

13. The method of claim 10 wherein the integration server may stream differing versions of a specific media selection based on playlist author preference, the capabilities of the media player device or environmental factors which may impact delivery of the streamed data.
